(19) United States
(12) Patent Application Publication
(10) Pub. No.: US 2011/0114609 A1
(43) Pub. Date: May 19, 2011

(54) METHOD AND DEVICE FOR FORMING THE WELDING WIRE END

(75) Inventors: Uwe Kroiss, Wilhering (AT); Walter Stieglbauer, Manning (AT); Josef Artelsmair, Wartberg (AT)

(73) Assignee: Fronius International GmbH, Pettenbach (AT)

(21) Appl. No.: 12/737,328

(22) PCT Filed: Jun. 22, 2009
(86) PCT No.: PCT/AT2009/000250

§ 371 Date: Dec. 30, 2010

(30) Foreign Application Priority Data
Jul. 30, 2008 (AT) A 1180/2008

(51) Int. Cl. B23K 15/00

(52) U.S. Cl. 219/121.11

(57) ABSTRACT

The invention relates to a method for forming an end of a welding wire (13) having a defined material and a defined diameter for a threading procedure, wherein the welding wire (13) is delivered from a wire storage via at least one wire core (12) through a contact tube arranged in a welding torch (10), and to a corresponding device thereof. In order to enable automated forming of the end of a welding wire (13), according to the invention prior to the threading procedure, an electric arc (15) is generated between a contact plate (30) connected to a power source (2) and the welding wire (13) as a function of the material and the diameter of the welding wire (13) so as to form the end of the welding wire (13), wherein the end of the welding wire (13) is formed to be hemispherical and the diameter of the hemispherical end of the welding wire (13) does not substantially exceed the diameter of the welding wire (13).

The invention relates to a method for forming an end of a welding wire having a defined material and a defined diameter for a threading procedure, wherein the welding wire is delivered from a wire storage via at least one wire core through a contact tube arranged in a welding torch.

The invention also relates to a device for forming an end of a welding wire for a threading procedure.

From the prior art, it is generally known that a continuous wire wound on a wire coil or unwound from a wire drum is required for a welding process using a consumable electrode. In that case, the ends of the welding wire are each cut off so as to have accordingly sharp edges and burrs. Prior to the welding process to be performed, it is necessary to thread a suitable welding wire into a wire core or a feeder, which is integrated in a hose package or externally supplied to a welding torch, respectively. In doing so, the wire core must not be damaged by the burr so as to prevent the welding wire from getting stuck in the wire core and the wire core from being damaged. In order to meet these requirements, the welding wire end to be inserted for threading into the wire core has to be rounded off. At present, this is done manually by rounding the end by the aid of a file or an appropriate grinding tool and removing the burr.

Yet, this involves the disadvantage of being time-consuming, in particular with harder welding wire materials (like chromium-nickel or steel). On the other hand, softer materials (like aluminum alloys) entail the risk of the welding wire bending due to the mechanical action. In such a case, the welding wire would have to be cut anew, and the burr would have to be removed once again.

The object of the invention, therefore, resides in providing an above-identified method and an above-identified device, which enable the end of a welding wire to be deformed or rounded by an automated procedure.

In method terms, the object of the invention is achieved in that, prior to the threading procedure, an electric arc is generated between a contact plate connected to a power source and the welding wire as a function of the material and the diameter of the welding wire so as to form the end of the welding wire, wherein the end of the welding wire is formed to be hemispherical and the diameter of the hemispherical end of the welding wire does not substantially exceed the diameter of the welding wire.

In doing so, it is advantageous that the end of the welding wire is formed for threading without damage by a rapid process very simple to handle. This will also ensure that the threading procedure will be independent of the length of a feeder, such as, for instance, in shipbuilding with a length of up to 70 meters.

In an advantageous manner, characteristic curves are established as a function of the material and the diameter of the welding wire and stored, and the electric arc is generated for forming the end of the welding wire based on the respective characteristic curve.

By the measure that the power source for generating the electric arc is activated by an activation signal, expenditures can be kept to a minimum, since an already available power source, i.e. that of the welding apparatus, can advantageously be used.

By generating the electric arc for forming the end of the welding wire, a voltage is applied by the power source between the contact plate and the welding wire.

As already mentioned above, it will be advantageous if the electric arc is generated by the power source of a welding apparatus, since this will keep expenditures to a minimum.

In this case, the power source can be switched from a welding output to a so-called threading output for forming the end of the welding wire and, after having formed the hemispherical end of the welding wire, can again be automatically switched from the threading output to the welding output.

In an advantageous manner, the electric arc is generated by contact ignition in that the welding wire is fixed by a clamping mechanism and contacted by a contacting device, the contact plate is moved to the welding wire and subsequently moved away from the welding wire.

Similarly, the electric arc can be generated by contact ignition in that the welding wire is conveyed to the contact plate by at least one conveying device and the welding wire is subsequently returned, wherein the welding wire is contacted by a contacting device.

If the contact plate can be moved out of alignment with the welding wire, it is possible that the welding wire is conveyed past the contact plate.

According to a further characteristic feature of the invention, it is provided that the electric arc is generated by contact ignition in that the welding wire is moved to the fixedly mounted contact plate by the movement of the welding torch and the welding wire is subsequently returned along with the welding torch, wherein the welding wire is contacted in the welding torch.

For a new threading procedure at a later time, the hemispherical end of the welding wire is advantageously formed at the end of a welding process.

It will be advantageous if the electric arc for forming the end of the welding wire is protected by a protective gas matched with the material of the welding wire.

The object of the invention is also achieved by an above-identified device in which a clamping mechanism, a contacting device and a contacting plate are arranged in alignment on a base plate, wherein the contact plate is movably mounted and the clamping mechanism and the contacting device are mounted on fixed positions of the base plate, and the contact plate and the contacting device are connected to a power source so as to enable an electric arc to be ignited between the welding wire held by the clamping mechanism and contacted by the contacting device and the contact plate, for forming the end of the welding wire.

In an advantageous manner, the power source is mounted on the base plate, or integrated in a welding apparatus, and connected with an operating element.

The contact plate can be movable to the welding wire and away from the welding wire by a motor or a magnet, the activation of said motor or said magnet depending on the actuation of the operating element.

The clamping mechanism for the welding wire can be configured mechanically, magnetically or electrically by a motor.

The object of the invention will also be achieved by an above-identified device, wherein a contacting device and a contact plate for contacting the welding wire are arranged in alignment on a base plate, and a conveying device for conveying the welding wire is associated with the base plate, and the contact plate and the contacting device are connected to a power source so as to enable an electric arc to be ignited between the welding wire conveyed by the conveying device and contacted by the contacting device and the contact plate.

In an advantageous manner, the contact plate is movably mounted on the base plate so as to be movable out of alignment with the welding wire. This will enable the welding wire to be conveyed past the contact plate.

The present invention will be explained in more detail by way of the schematic drawings attached. Therein:

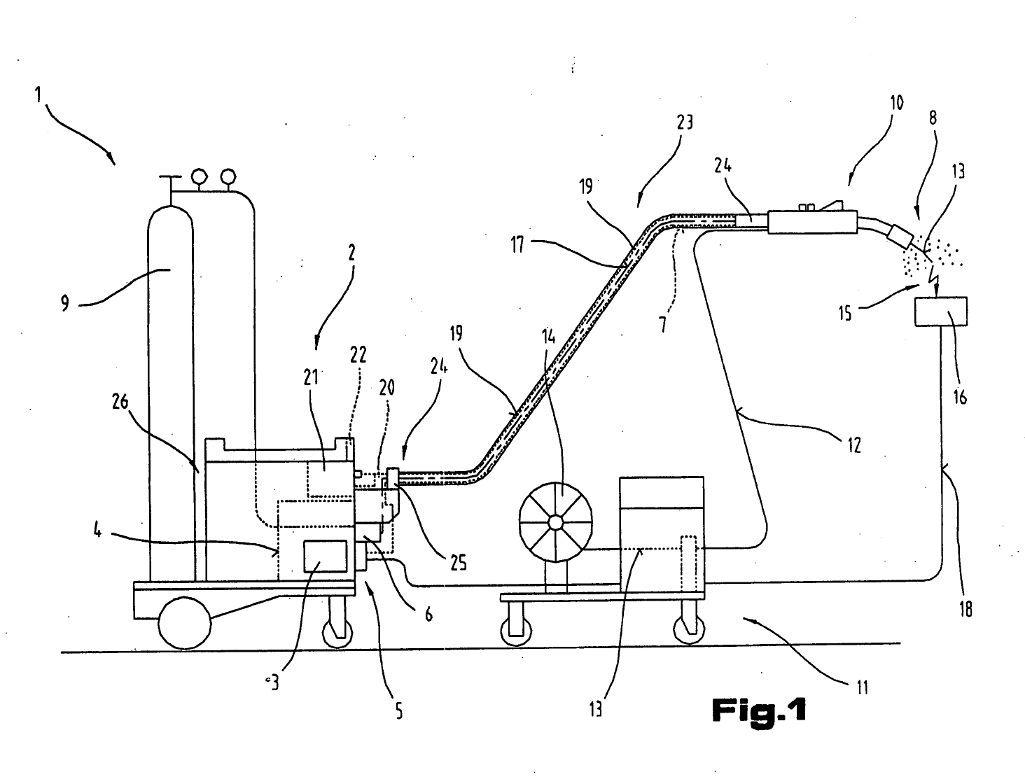

FIG. 1 is a schematic illustration of a welding machine or welding apparatus,

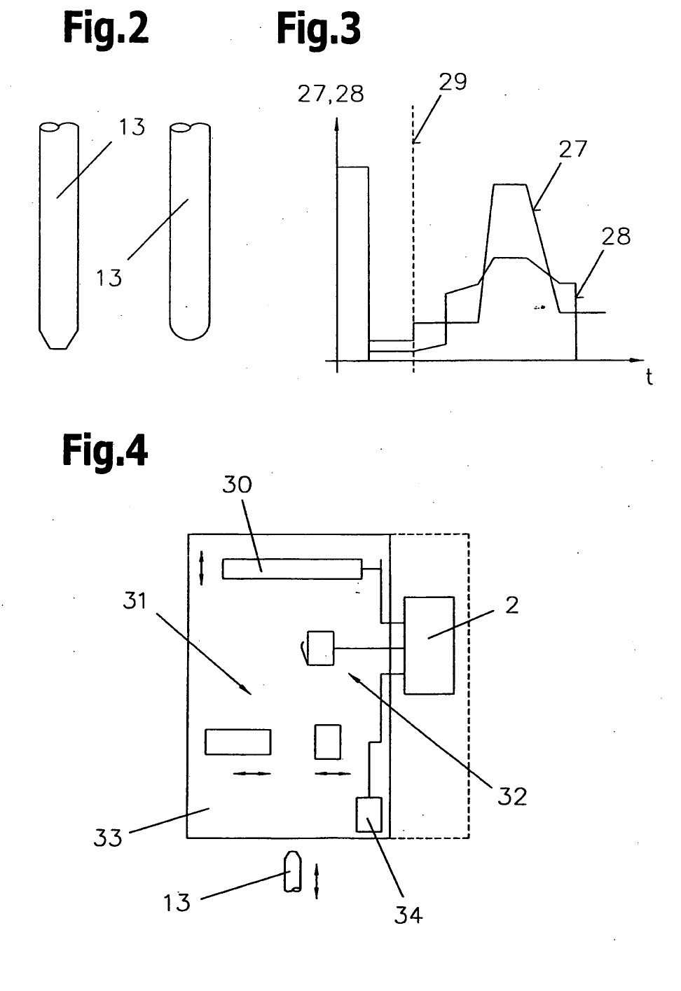

FIG. 2 depicts an end of a welding wire before and after the execution of the method according to the invention;

FIG. 3 illustrates the current/voltage course during the formation of the welding wire end;

FIG. 4 depicts a first variant of the device according to the invention for forming the end of a welding wire;

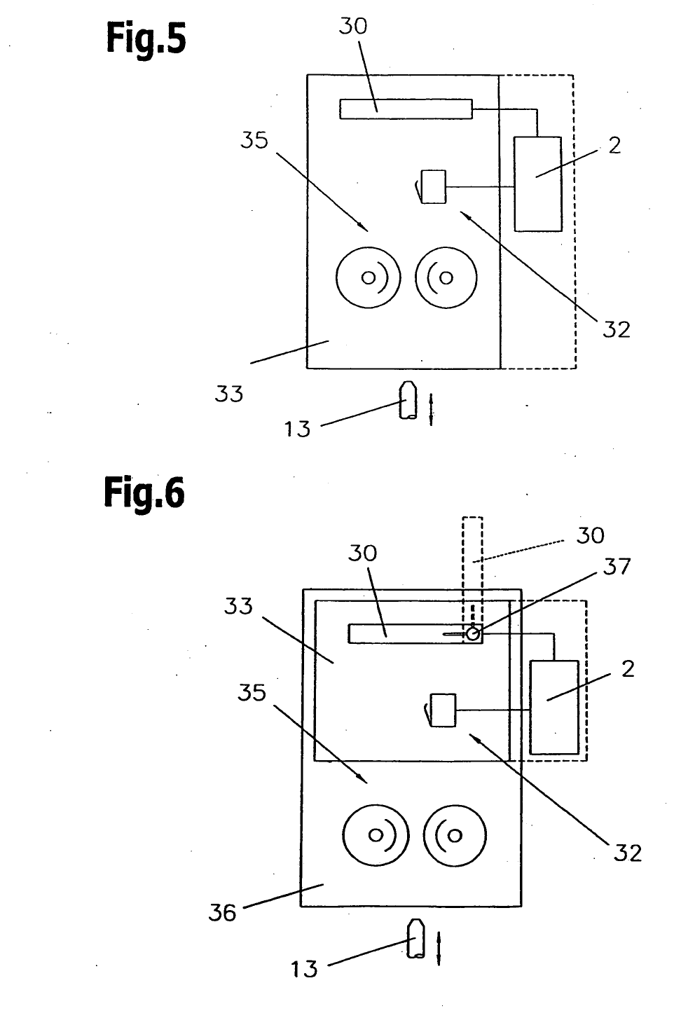

FIG. 5 depicts a second variant of the device according to the invention;

FIG. 6 depicts a third variant of the device according to the invention;

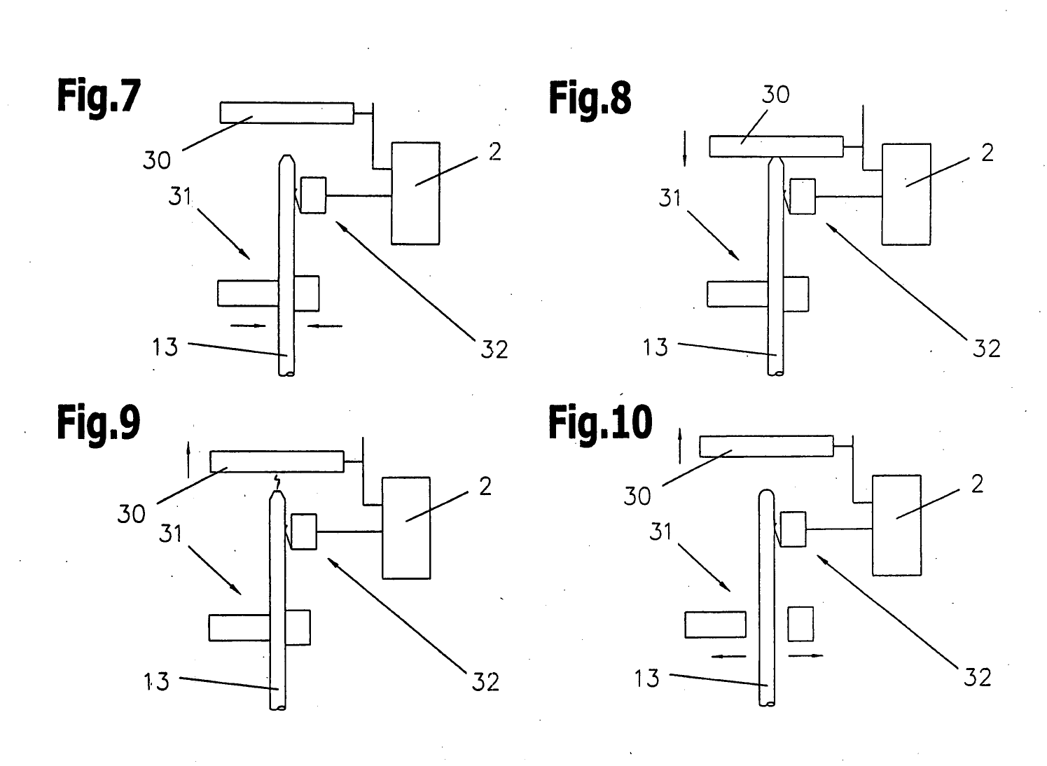

FIGS. 7 to 10 illustrate the execution of the method according to the invention using the first variant of the device according to the invention; and

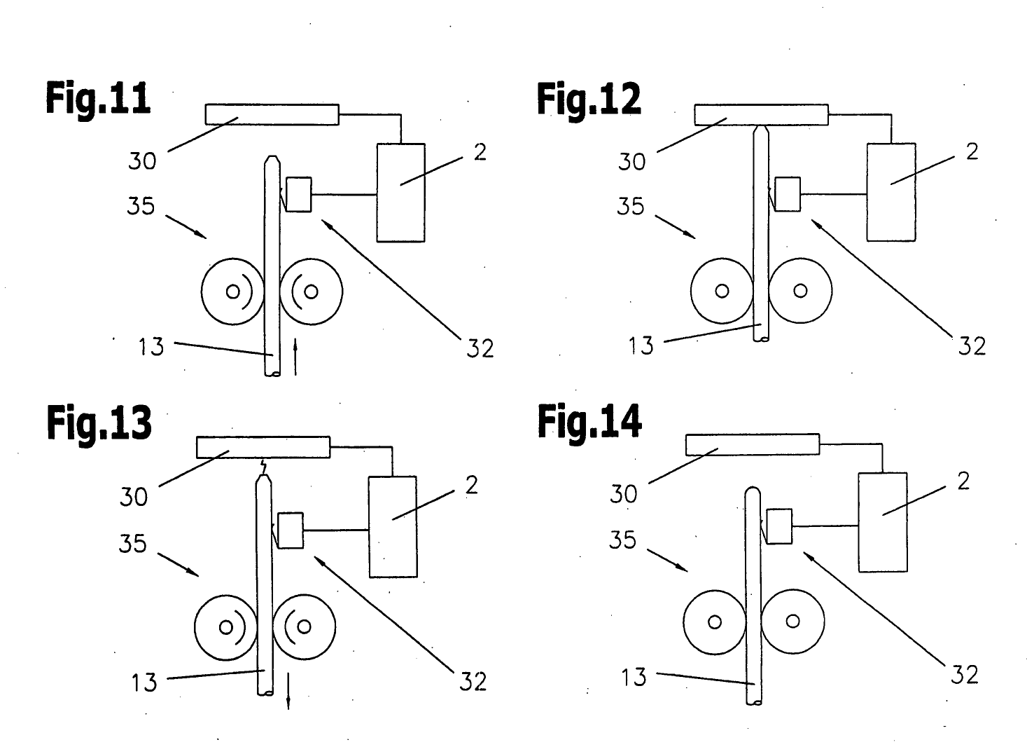

FIGS. 11 to 14 illustrate the execution of the method according to the invention using the second variant of the device according to the invention.

To begin with, it is noted that identical parts of the exemplary embodiment are denoted by the same reference numerals.

FIG. 1 depicts a welding apparatus 1, or welding installation, for various processes or methods such as, e.g., MIG/MAG welding or WIG/TIG welding, electrode welding methods, double-wire/tandem welding methods, plasma or soldering methods etc.

The welding apparatus 1 comprises a power source 2 including a power element 3, a control device 4, and a switch member 5 associated with the power element 3 and control device 4, respectively. The switch member 5 and the control device 4 are connected with a control valve 6 arranged in a feed line 7 for a gas 8, in particular a protective gas such as, for instance, carbon dioxide, helium or argon and the like, between a gas reservoir 9 and a welding torch 10 or torch.

In addition, a wire feeder 11, which is usually employed in MIG/MAG welding, can be activated by the control device 4, wherein a filler material or welding wire 13 is fed from a wire storage or storage drum 14, such as a wire coil or wire drum, into the region of the welding torch 10 via a feed line or what is called a wire core 12. It is, of course, possible to integrate the wire feeder 11 in the welding apparatus 1 and, in particular, its basic housing, as is known from the prior art, rather than designing the same as an accessory device as illustrated in FIG. 1.

It is also possible for the wire feeder 11 to supply the welding wire 13, or filler metal, to the process site outside the welding torch 10, to which end a non-consumable electrode is preferably arranged within the welding torch 10, as is usually the case with WIG/TIG welding.

The power required for building up an electric arc 15, in particular an operative electric arc, between the non-consumable electrode (not illustrated) and a workpiece 16 is supplied from the power element 3 of the power source 2 to the welding torch 10, in particular electrode, via a welding line 17, wherein the workpiece 16 to be welded, which is preferably comprised of several parts, via a further welding line 18 is likewise connected with the welding apparatus 1 and, in particular, power source 2 so as to enable a power circuit for a process to build up over the electric arc 15, or the plasma jet formed.

For cooling the welding torch 10, the welding torch 10 can be connected to a fluid reservoir, in particular water reservoir 21, by a cooling circuit 19 via an interposed flow control 20 so as to start the cooling circuit 19, in particular a fluid pump used for the fluid contained in the water reservoir 21, when the welding torch 10 is put into operation, and hence effect cooling of the welding torch 10.

The welding apparatus 1 further comprises an input and/or output device 22, via which the most different welding parameters, operating modes or welding programs of the welding apparatus 1 can be set and called, respectively. In doing so, the welding parameters, operating modes or welding programs set via the input and/or output device 22 are transmitted to the control device 4, which will subsequently activate the individual components of the welding apparatus 1 and/or preset the respective values required for controlling.

In the exemplary embodiment illustrated, the welding torch 10 is further connected with the welding apparatus 1 via a hose pack 23. The hose pack 23 houses the individual lines from the welding apparatus 1 to the welding torch 10. The hose pack 23 is connected with the welding torch 10 via a coupling mechanism 24, whereas the individual lines arranged within the hose pack 23 are connected with the individual contacts of the welding apparatus 1 via connection sockets or plug-in connections. In order to ensure the appropriate strain relief of the hose pack 23, the hose pack 23 is connected with a housing 26, in particular the basic housing of the welding apparatus 1, via a strain relief means 25. It is, of course, possible to use the coupling mechanism 24 also for connection to the welding apparatus 1.

It should basically be noted that not all of the previously mentioned components need to be used or employed for the different welding methods or welding apparatus 1 such as, e.g., WIG devices or MIG/MAG apparatus or plasma devices. Thus, it is, for instance, possible to realise the welding torch 10 as an air-cooled welding torch 10.

When performing a welding process using a consumable welding wire 13, such as the MIG/MAG process, it is to be borne in mind amongst other things that the appropriate material and diameter be selected for the welding wire 13. Thus, if the welding wire 13 present in the wire core 12 does not meet the desired requirements, it must be exchanged. This means that the welding wire 13 is to be returned onto the wire coil 14 or back into the wire drum. After this, the welding wire 13 required for the subsequent welding process can be threaded in.

Such a threading procedure comprises the conveyance of the welding wire 13, starting from the wire feeder 11, via the at least one wire core 12 (within the hose pack 23 or externally guided) and through a contact tube in the welding torch 10 such that the welding wire 13 will subsequently be available at the welding site on the workpiece 16.

Depending on the welding process, the wire core 12 can be interrupted in a region as is, for instance, the case with CMT welding because of what is referred to as the wire buffer. Such a wire buffer calls for special attention during the threading procedure. It requires the end or beginning of the welding wire 13 to be to rounded off in order not to damage the wire core(s) 12.

In accordance with the invention, this is done in that the welding wire 13 is incipiently melted by igniting an electric arc 15 such that its end will be formed in a hemispherical fashion. The welding wire 13 can thus at least be threaded into the wire core 12 without damaging the latter.

In the following, a way of rounding the end of the welding wire 13 by means of the electric arc 15 so as to ensure a safe threading procedure will be described in detail by way of FIGS. 2 to 14. The threading procedure as such will not be discussed in detail, because it is generally known from the prior art.

FIG. 2 is a detailed view of the welding wire 13 prior to forming or rounding (left-hand side) and after forming or rounding (right-hand side), respectively, using the method according to the invention. After forming, the welding wire 13 is substantially hemispherical on its end, with the diameter of the hemisphere not exceeding the diameter of the welding wire 1. This is an essential precondition for the method according to the invention, since a diameter of the hemisphere larger than that of the welding wire 13 would cause the latter to be stuck in the wire core 12.

This precondition is substantially met in that a characteristic curve is established and stored for each material/diameter combination of the welding wire 13, according to which the forming procedure is performed. The energy input of the electric arc 15 into the welding wire 13 is controlled by the power source 2 according to the stored characteristic curve. The characteristic curves are preferably stored in the control device 4 of the power source 2 and activated as a function of the set material and diameter of the welding wire 13.

A characteristic curve is formed by a plurality of parameters, the course of the curve of the two main parameters, i.e. current 27 and voltage 28, being, for instance, illustrated as a function of the time t in FIG. 3. From this, it is particularly apparent that contact ignition is effected until a time 29, with a voltage 28 being applied between a contact plate 30 and the welding wire 13. As the welding wire 13 contacts the contact plate 30, a short-circuit is created, which is recognized by the power source 2. After that, the current 27 is increased so as to enable the formation of the electric arc 15 between the welding wire 13 and the contact plate 30 when the short-circuit is broken at time 29. From time 29, the courses of the current 27 and the voltage 28 are selected such that the end of the welding wire 13 is incipiently melted and formed to be hemispherical. This is, in particular, achieved by a main pulse of the current 27. And, according to the invention, the diameter of the hemisphere will not exceed the diameter of the welding wire 13. It is also apparent that the current 27 is intentionally dropped to zero after the main pulse such that the electric arc 15 will be extinguished in a defined manner. Thereby, the precisely formed hemisphere is substantially obtained and not modified any more.

In the following FIGS. 4 to 6, different variants of the device according to the invention for carrying out the method of the invention are illustrated.

In FIG. 4, the device comprises a clamping mechanism 31, a contacting device 32 and a contact plate 30, which are mounted on a base plate 33. The arrangement is aligned such that the welding wire 13 will at first be moved through the clamping mechanism 31, can subsequently be contacted by the contacting device 32 at least on one side, and will finally abut on the contact plate 30. The contact plate 30 constitutes the counter-pole to the welding wire 13. For that purpose, the contact plate 30 and the contacting device 32 are connected to the power source 2 so as to enable the generation of the electric arc 15 between the welding wire 13—which is, for instance, contacted by a spring of the contacting device 32—and the contact plate 30. To this end, the welding wire 13 is firmly held by the clamping mechanism 31, which is horizontally movable in the sense of the arrows, and the contact plate 30 is arranged to be movable in the vertical direction (arrow). The current circuit can thus be closed and an electric arc 15 can thus be formed by contact ignition. The connection to the power source 2 must, therefore, also be flexible. The power source 2 can either be arranged on the base plate 33 so as to enable the generation, or execution, of the electric arc 15 and the method according to the invention, respectively, independently of the welding apparatus 1, or the power source 2 may correspond to the power source 2 within the welding apparatus 1. If the power source 2 is arranged on the base plate 33, the latter will be extended according to the broken line.

If the power source 2 corresponds to that within the welding apparatus 1, the contact plate 30 and/or the contacting device 32 is/are arranged in parallel with the output for the welding torch 10. It is, of course, also possible for the power source 2 to have two separate outputs, thus the power source 2 may, for instance, comprise a so-called threading output in addition to its regular output, wherein switching between these two outputs is feasible.

The activation and/or control for forming the end of the welding wire 13 is substantially performed by the power source 2. The power source 2 preferably initiates the required measures based on an activation signal in order to form the end of the welding wire 13 accordingly. The device illustrated is basically suitable for a manual welder. The activation signal is generated by the actuation of an operating element 34 connected with the power source 2. The operating element 34 is arranged on the base plate 33, integrated in a housing placed on the base plate 33 and/or arranged on the input/output device 22 of the welding apparatus 1. Consequently, also the clamping mechanism 31 and the movements of the contact plate 30 are controlled by the power source 2. It is, of course, also possible that the clamping mechanism 31 is of the mechanical type and the user fixes the welding wire 13 manually.

According to FIG. 5, the device is comprised of a conveying device 35, the contacting device 32 and the contact plate 30, which are mounted in alignment on the base plate 33. The contact plate 30 and the contacting device 32 are again connected with the power source 2 in a manner that the electric arc 15 can be generated by contact ignition between the welding wire 13 and the contact plate 30 to form the end of the welding wire 13.

The conveying device 35 substitutes for the clamping mechanism 31 of the device depicted in FIG. 4. Unless otherwise described below, the explanations of FIG. 4 also apply to FIG. 5. By the conveying device 35, which is preferably formed by two conveying rollers, the welding wire 13 can be moved in the direction of the fixedly mounted contact plate 30 and back again. The welding wire 13 is conducted past the contacting device 32 so as to be contacted by the same.

A device of this type can be used both in manual welders and in automated welding installations. When used in manual welders, the activation signal is again produced by an operating element 35 (not illustrated). By contrast, when used in automated welding installations, the activation signal is, for instance, generated by a master sequential control system, e.g. a robot control, or at the end of a welding job.

FIG. 6 depicts a further device, which substantially corresponds to that of FIG. 5. Unless otherwise described below, the explanations in respect to FIGS. 4 and 5 will thus also apply to FIG. 6. In this case, it is essential that the method according to the invention is executed in an auxiliary drive subsequently conveying the welding wire 13 beyond the contact plate 30. The conveying device 35 thus corresponds to that of the auxiliary drive, which is mounted on a motor plate 36 and can be integrated in an appropriate housing. Only the contact plate 30 and the contacting device 32 are still arranged on the base plate 33. Optionally, also the power source 2 may be mounted on the base plate 33.

In order for the welding wire 13 to be conveyable beyond the contact plate 30, the latter has to be movable. Thus, a shaft 37 is, for instance, integrated in the contact plate 30 on one side thereof in order to make the latter pivotable by a motor, magnet etc. This is illustrated by the vertical contact plate 30 indicated by broken lines. Also the contacting device 32 can be accordingly moved away from the welding wire 13 so as not to offer any resistance during the conveyance of the welding wire 13 and avoid any current conduction.

The field of application of this variant comprises wire exchange systems for wire drums, i.e. automated welding installations. Yet, this variant may as well be used with wire drives in the wire feeder 11, i.e. with manual welders.

In FIGS. 7 to 14, the method according to the invention is described by way of two variants of the device according to the invention. In doing so, the method for forming the end of the welding wire 13 is discussed in detail, without elaborating the previously described structural details. To start with, it should be noted that the illustrated arrows serve to denote the respective moving directions of the associated components like the contact plate 30, the clamping mechanism 31, the conveying device 35 or the welding wire 13 (as already also in FIGS. 4 to 6).

In the following, the method will be described by way of FIGS. 7 to 10, using the clamping mechanism according to FIG. 4.

As is apparent from FIG. 7, the welding wire 13 is at first moved through the clamping mechanism 31, past the contacting device 32, substantially as far as to the contact plate 30. After this, the clamping mechanism 31 is closed. Preferably by a motor, by hand, by a magnet etc., so that the welding wire 13 is fixed and aligned. Hence follows substantially automatically that the welding wire 13 is contacted by the contacting device 32. Depending on how close the welding wire 13 has been moved to the contact plate 30, already a contact or a short-circuit, or yet an undefined distance, is thus provided. This will be recognized by the power source 2 by applying a voltage 28 between the contacting device 32 and the contact plate 30. If the voltage 28 breaks down or becomes almost zero, a short-circuit will be present; if the applied voltage 28 is being maintained, a short-circuit will have to be produced.

As is apparent from FIG. 8, this is effected in a manner that the contact plate 30 is moved in the direction of the welding wire 13 by a motor, magnet etc., until the power source 2 recognizes a short-circuit, which is necessary for contact ignition. As already known from FIG. 3, the current 27 will then be increased so as to enable the electric arc 15 to be ignited during the subsequent backward movement of the contact plate 30 as illustrated in FIG. 9. Based on the course of the voltage 28, the current source 2 will recognize the burning electric arc 15 and generate the main pulse, thus causing the welding wire 13 to be incipiently melted in a defined manner so as to form its hemispherical end. This is effected according to the characteristic curve selected in terms of welding wire diameter and material. After the electric arc 15 has been extinguished in a defined manner, the contact plate 30 is moved into its starting position as illustrated in FIG. 10. Subsequently, the clamping mechanism 31 is released again so as to enable the welding wire 13 with its hemispherically designed end to be removed for the threading procedure.

In FIGS. 11 to 14 below, the method using the conveying device 35 according to FIGS. 5 and 6 will be described.

Basically, the method according to FIGS. 7 to 10 is applicable mutatis mutandis. The difference resides in that the conveying device 35 now transports the welding wire 13 to the contact plate 30 and away from the contact plate 30. The contact plate 30 will not change its position during the method for forming the end of the welding wire 13. The contact plate 30 may merely be pivoted as in correspondence with FIG. 6, so that the welding wire 13 can be conveyed past the contact plate 30.

The method can also be performed by a robot in that the latter positions the welding torch 10 in the position in which the contact plate 30 is mounted. No contacting device 32 is thus required, since this function is taken over by a contact tube provided in the welding torch 10. Moreover, no additional conveying device 35 is necessary either, because the welding wire 13 has already been transported. The forming of the end of the welding wire 13 in this case is effected for the subsequent threading procedure of this welding wire 13. The method according to the invention is thus performed prior to exchanging the welding wire 13.

Finally, it should be mentioned that suitable electrically conductive materials such as copper are used for the contact plate 30 and the contacting device 32 so as to ensure the proper performance of the method according to the invention.

Similarly, the activation and/or control of the conveying device 35, the clamping mechanism 31 and/or the motor, magnets etc. for moving the contact plate 30 may also be performed by an external control. This will then be preferably connected with the power source 2 via a data link to enable the execution of the method according to the invention.

It goes without saying that in the method according to the invention no droplet is detached from the welding wire 13 as would happen in a welding process. This is in fact not possible, not least because the burning time of the electric arc 15 for the respective welding wire 13 is extremely short, e.g. in the millisecond range or below. This time suffices to melt open the end of the welding wire 13 and form the hemispherical shape.

It should also be noted that a short-circuit between the welding wire 13 and the contact plate 30 can be recognized by measuring the motor current of the conveying device 35 or of the motor moving the contact plate 30.

Safety measures may also be taken in that it is, for instance, waited for a defined period after having formed the end of the welding wire 13, until the clamping mechanism 31 is released and the conveying device 35 moves the welding wire 13 on in the respective direction.

1. A method for forming an end of a welding wire (13) having a defined material and a defined diameter for a threading procedure, wherein the welding wire (13) is delivered from a wire storage via at least one wire core (12) through a contact tube arranged in a welding torch (10), wherein, prior to the threading procedure, an electric arc (15) is generated between a contact plate (30) connected to a power source (2) and the welding wire (13) as a function of the material and the diameter of the welding wire (13) so as to form the end of the welding wire (13), wherein the end of the welding wire (13) is formed to be hemispherical and the diameter of the hemispherical end of the welding wire (13) does not substantially exceed the diameter of the welding wire (13).

2. A method according to claim 1, wherein characteristic curves are established as a function of the material and the diameter of the welding wire (13) and stored, and wherein the electric arc (15) for forming the end of the welding wire (13) is generated based on the respective characteristic curve.

3. A method according to claim 1, wherein the power source (2) for generating the electric arc (15) is activated by an activation signal.

4. A method according to claim 3, wherein a voltage (28) is applied by the power source (2) between the contact plate (30) and the welding wire (13).

5. A method according to claim 1, wherein the electric arc (15) is generated by the power source (2) of a welding apparatus (1).

6. A method according to claim 5, wherein the power source (2) is switched from a welding output to a threading output for forming the end of the welding wire (13) and wherein, after having formed the hemispherical end of the welding wire (13), the power source (2) is automatically switched from the threading output to the welding output.

7. A method according to claim 1, wherein the electric arc (15) is formed by contact ignition in that the welding wire (13) is fixed by a clamping mechanism (31) and contacted by a contacting device (32), the contact plate (30) is moved to the welding wire (13) and subsequently moved away from the welding wire (13).

8. A method according to claim 1, wherein the electric arc (15) is formed by contact ignition in that the welding wire (13) is conveyed to the contact plate (30) by at least one conveying means (35) and the welding wire (13) is subsequently returned, wherein the welding wire (13) is contacted by a contacting device (32).

9. A method according to claim 8, wherein the contact plate (30) is moved out of alignment with the welding wire (13) and the welding wire (13) is conveyed past the contact plate (30).

10. A method according to claim 1, wherein the electric arc (15) is generated by contact ignition in that the welding wire (13) is moved to the fixedly mounted contact plate (30) by the movement of the welding torch (10) and the welding wire (13) is subsequently returned along with the welding torch (10), wherein the welding wire (13) is contacted in the welding torch (10).

11. A method according to claim 8, wherein, for a new threading procedure at a later time, the end of the welding wire (13) is hemispherically formed at the end of a welding process.

12. A method according to claim 1, wherein the electric arc (15) is protected by a protective gas matched with the material of the welding wire (13).

13. A device for forming an end of a welding wire (13) for a threading procedure, wherein a clamping mechanism (31), a contacting device (32) and a contacting plate (30) are arranged in alignment on a base plate (33), wherein the contact plate (30) is movably mounted and the clamping mechanism (31) and the contacting device (32) are mounted on fixed positions of the base plate (33), and the contact plate (30) and the contacting device (32) are connected to a power source (2) so as to enable an electric arc (15) to be ignited between the welding wire (13) held by the clamping mechanism (31) and contacted by the contacting device (32) and the contact plate (30), for forming the end of the welding wire (13).

14. A device according to claim 13, wherein the power source (2) is mounted on the base plate (33), or integrated in a welding apparatus (1), and connected with an operating element (34).

15. A device according to claim 13, wherein the contact plate (30) is movable to the welding wire (13) and away from the welding wire (13) by a motor or a magnet, the activation of said motor or said magnet depending on the actuation of the operating element (34).

16. A device according to claim 13, wherein the clamping mechanism (31) for the welding wire (13) is configured mechanically, magnetically or electrically by a motor.

17. A device for forming an end of a welding wire (13) for a threading procedure, wherein a contacting device (32) and a contacting plate (30) for contacting the welding wire (13) are arranged in alignment on a base plate (33), and a conveying device (35) for conveying the welding wire (13) is associated with the base plate (33), and the contact plate (30) and the contacting device (32) are connected to a power source (2) so as to enable an electric arc (15) to be ignited between the welding wire (13) conveyed by the conveying device (35) and contacted by the contacting device (32) and the contact plate (30).

18. A device according to claim 17, wherein the contact plate (30) is movably mounted on the base plate (33) so as to be movable out of alignment with the welding wire (13).
